(19) United States
(12) Patent Application Publication
(10) Pub. No.: US 2025/0220640 A1
(43) Pub. Date: Jul. 3, 2025

(54) PHASE COMPENSATION METHOD, APPARATUS, DEVICE, AND STORAGE MEDIUM

(71) Applicant: Lenovo (Beijing) Limited, Beijing (CN)

(72) Inventors: Xuefeng LAI, Beijing (CN); Yi LI, Beijing (CN); Rui CHEN, Beijing (CN)

(21) Appl. No.: 18/999,800

(22) Filed: Dec. 23, 2024

(30) Foreign Application Priority Data
Dec. 29, 2023 (CN) 202311864442.6

(51) Int. Cl. H04W 72/044; H04L 27/26

(52) U.S. Cl. CPC H04W 72/044; H04L 27/265

(57) ABSTRACT

A phase compensation method includes: converting, by a radio frequency (RF) remote unit hub, time domain data received from an RF remote unit into frequency domain data; and performing, by a baseband processing unit, resource de-mapping on the frequency domain data to obtain a first time-frequency resource with phase compensation completed and a second time-frequency resource without phase compensation. The first time-frequency resource corresponds to a first channel and the second time-frequency resource corresponds to a second channel.

### CROSS-REFERENCE TO RELATED APPLICATION

This application claims priority to Chinese Patent Application No. 202311864442.6, filed on Dec. 29, 2023, and the entire content of which is incorporated herein by reference.

### TECHNICAL FIELD

The present disclosure relates to the technical field of wireless communications, and more particularly, to a phase compensation method, apparatus, device, and storage medium.

### BACKGROUND

The maximum bandwidth supported by 5G base stations is 100 M. Because terminals do not necessarily require such a large bandwidth, some bandwidth (bandwidth par or BWP) is divided. In the process of similar communication between terminals using BWP, a problem may occur when a center frequency f1 of a base station is inconsistent with a center frequency f0 of a terminal BWP, resulting in a larger phase deviation of symbols received by the base station. Phase compensation is required when the 5G base station receives a terminal signal for processing and when the terminal receives a downlink signal of the 5G base station. However, for a physical random access channel (PRACH), due to the shift property of fast Fourier transform (FFT), a constant fixed phase will be retained in the time-frequency domain, and power delay profile (PDP) detection will not be affected by an additional fixed phase. Therefore, PRACH does not require additional phase compensation.

Open RAN refers to that base stations can be built through open source software, open interfaces, and white box hardware, thereby reducing industry costs. To facilitate the white box hardware, the main BBU of the base station should run on a general server to facilitate software and hardware decoupling.

To implement different phase compensation strategies for different channels in the prior art, the time domain data received by an RRU Hub under the Open RAN architecture is subject to cyclic prefix (CP) removal, and the spectrum is moved, such that the spectrum of the baseband signal is moved to the spectrum centered on direct current (DC), and then down-sampling and low-pass filtering are performed in the time domain. FFT is used to extract the time and frequency domain information of PRACH separately. For the time domain data of other channels, the RRU Hub directly uses FFT to convert it into frequency domain information, and then performs phase compensation in the frequency domain. As such, except for PRACH, other uplink channels are phase compensated. Because the implementation of phase compensation requires substantial computing power of the field programmable gate array (FPGA) in the RRU HUB, it places a substantial dependency on the FPGA. Therefore, simplifying the functions of general-purpose hardware FPGA and reducing the dependency on the FPGA become an urgent problem to solve.

### SUMMARY

One aspect of the present disclosure provides a phase compensation method. The phase compensation method includes: converting, by a radio frequency (RF) remote unit hub, time domain data received from an RF remote unit into frequency domain data; and performing, by a baseband processing unit, resource de-mapping on the frequency domain data to obtain a first time-frequency resource with phase compensation completed and a second time-frequency resource without phase compensation. The first time-frequency resource corresponds to a first channel and the second time-frequency resource corresponds to a second channel.

Another aspect of the present disclosure provides a phase compensation apparatus. The phase compensation apparatus includes: a radio frequency (RF) remote unit hub configured to convert time domain data received from an RF remote unit into frequency domain data; and a baseband processing unit configured to perform resource de-mapping on the frequency domain data to obtain a first time-frequency resource that has completed phase compensation and a second time-frequency resource without the phase compensation. The first time-frequency resource corresponds to a first channel and the second time-frequency resource corresponds to a second channel.

Another aspect of the present disclosure provides a computer-readable storage medium storing a computer program. When being executed by a processor, the computer program causes the processor to: convert, by a radio frequency (RF) remote unit hub, time domain data received from an RF remote unit into frequency domain data; and perform, by a baseband processing unit, resource de-mapping on the frequency domain data to obtain a first time-frequency resource with phase compensation completed and a second time-frequency resource without phase compensation. The first time-frequency resource corresponds to a first channel and the second time-frequency resource corresponds to a second channel.

### BRIEF DESCRIPTION OF THE DRAWINGS

FIG. 1 is a flowchart of a phase compensation method according to some embodiments of the present disclosure;

FIG. 2 is a flowchart of another phase compensation method according to some embodiments of the present disclosure;

FIG. 3 is a flowchart of another phase compensation method according to some embodiments of the present disclosure;

FIG. 4A is a flowchart of another phase compensation method according to some embodiments of the present disclosure;

FIG. 4B is a flowchart of another phase compensation method according to some embodiments of the present disclosure;

FIG. 5 is a schematic structural diagram of a phase compensation apparatus according to some embodiments of the present disclosure; and

FIG. 6 is a schematic diagram of a hardware architecture of an electronic device according to some embodiments of the present disclosure.

### DETAILED DESCRIPTION OF THE EMBODIMENTS

To clearly and completely describe the technical solutions in the embodiments of the present application, the present disclosure is described in detail below in conjunction with the drawings and specific implementation methods. Obviously, the described embodiments are merely part of the embodiments of the present disclosure, not all of the embodiments. Based on the embodiments in the present disclosure, all other embodiments obtained by ordinary people skilled in the art without creative work are within the scope of protection of the present disclosure.

In the following description, “some embodiments” are used to describe a subset of all possible embodiments, but it can be understood that “some embodiments” can be the same subset or different subsets of all possible embodiments, and can be combined with each other without conflict.

The terms “first/second/third” are only used to distinguish similar objects, and do not represent a specific order for the objects. It can be understood that “first/second/third” can be interchanged with a specific order or sequence where permitted, such that the embodiments of the present disclosure described herein can be implemented in an order other than that illustrated or described here.

Unless otherwise defined, all technical and scientific terms used in this specification have the same meaning as those generally understood by those skilled in the art of the present disclosure. The terms used in this specification are merely for the purpose of describing the present disclosure and are not intended to limit the present disclosure.

Before further describing the embodiments of the present disclosure in detail, the terms involved in the embodiments of the present disclosure are described. The terms involved in the embodiments of the present disclosure are applicable to the following definitions.

ORAN (Open RAN) refers to building base stations through open source software, open interfaces, and white box hardware, thereby reducing industry costs. To facilitate white box hardware, the main body of the base station must run on a general-purpose server to facilitate software and hardware decoupling.

Currently, the main body of Open RAN includes key modules such as base band unit (BBU), remote radio unit (RRU), and RRU Hub. The BBU includes distributed units (DU) and a centralized unit (CU).

Field programmable gate array (FPGA) is a semi-custom circuit in application-specific integrated circuits. It is a programmable logic array that can effectively solve the problem of the small number of gate circuits of the original device.

Physical random access channel (PRACH) is an access channel when the terminal initiates a call. After receiving a PRACH response message, the terminal will send a radio resource control (RRC) connection request message on the PRACH channel according to the information indicated by the base station to establish an RRC connection.

Physical uplink shared channel (PUSCH) is used to carry data from a transmission channel.

Physical uplink control channel (PUCCH) is used to transmit control information between the terminal and the base station.

Sounding reference signal (SRS) is a reference signal sent by the terminal for the base station to measure and evaluate the uplink channel propagation quality.

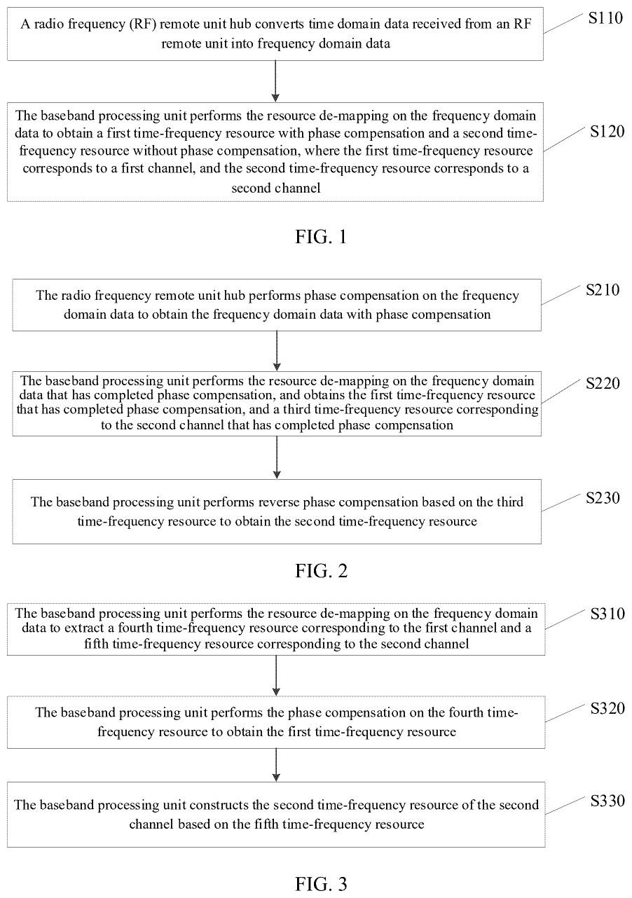

The present disclosure provides a phase compensation method. FIG. 1 is a flowchart of a phase compensation method according to some embodiments of the present disclosure. As shown in FIG. 1, the method includes the following processes.

At S110, a radio frequency (RF) remote unit hub converts time domain data received from an RF remote unit into frequency domain data.

Here, the RF remote unit hub (RRU HUB) may be connected to the RF remote unit (RRU) through a common public radio interface (CPRI) or an enhanced CPRI (eCPRI) to receive the time domain data sent by the RRU. CPRI is based on circuit switching time division multiplexing (TDM), while eCPRI is based on packet switching. Thus, CPRI naturally carries synchronization information, while eCPRI needs to be synchronized through clock synchronization, for example, through precision time protocol (PTP) and synchronous Ethernet (SyncE) technology.

The frequency domain data includes data of PUSCH, PUCCH, SRS and PRACH channels.

For example, a 4096-point FFT uplink or inverse FFT (IFFT) downlink with a bandwidth of 100 M may be implemented on the RRU Hub without distinguishing channels. Then, resource de-mapping of each channel is uniformly implemented in the BBU, and the PRACH, PUSCH, PUCCH and SRS channels are uniformly processed in the BBU.

At S120, the baseband processing unit performs the resource de-mapping on the frequency domain data to obtain a first time-frequency resource with phase compensation and a second time-frequency resource without phase compensation, where the first time-frequency resource corresponds to a first channel, and the second time-frequency resource corresponds to a second channel.

In some embodiments, the first channel includes at least one of the following: a physical uplink shared channel, a physical uplink control channel, and a channel sounding reference signal. The second channel is a physical random access channel.

Here, for the physical random access channel (PRACH), due to the shift property of FFT, a constant fixed phase may be retained in the time-frequency domain, and power delay profile (PDP) detection may not be affected by an additional fixed phase, so no additional phase compensation is required. Therefore, the second time-frequency resource does not need to be phase compensated.

According to the provisions of protocol 38.211, the physical uplink shared channel, physical uplink control channel, and the channel sounding reference signal need to be phase compensated.

During the implementation process, the baseband processing unit performs the resource de-mapping on the frequency domain data to obtain the first time-frequency resource with phase compensation and the second time-frequency resource without phase compensation to satisfy the protocol provisions.

In the embodiment of the present disclosure, the RF remote unit hub first converts the time domain data received from the RF remote unit into frequency domain data. Then the baseband processing unit performs the resource de-mapping on the frequency domain data to obtain the first time-frequency resource with phase compensation and the second time-frequency resource without phase compensation. The first time-frequency resource corresponds to the first channel and the second time-frequency resource corresponds to the second channel. As such, the conversion of the time domain data and the frequency domain data may be achieved on the RRU Hub without distinguishing channels. The resource de-mapping of each channel is uniformly achieved on the BBU. The PRACH, PUSCH, PUCCH and SRS channels are uniformly processed on the BBU. Releasing part of the computing power of the RF remote unit hub to the baseband processing unit effectively reduces the FPGA computing power and capacity requirements of the RF remote unit hub.

FIG. 2 is a flowchart of another phase compensation method according to some embodiments of the present disclosure. In some embodiments, as shown in FIG. 2, the process S120 “the baseband processing unit performs the resource de-mapping on the frequency domain data to obtain the first time-frequency resource with phase compensation and the second time-frequency resource without phase compensation” may be implemented by the following processes.

At S210, the radio frequency remote unit hub performs phase compensation on the frequency domain data to obtain the frequency domain data with phase compensation.

The frequency domain data includes data of PUSCH, PUCCH, SRS and PRACH channels.

In the process, the RRU HUB converts the received time domain data into the frequency domain data using FFT. Then the phase compensation function may be implemented on the RRU Hub using FPGA logic.

For example, a 4096-point FFT uplink or IFFT downlink with a bandwidth of 100 M may be implemented on the RRU Hub without distinguishing channels. Then, the phase compensation of each channel is uniformly performed on the RRU Hub to obtain the frequency domain data of the PUSCH, PUCCH, SRS and PRACH channels with phase compensation.

At S220, the baseband processing unit performs the resource de-mapping on the frequency domain data that has completed phase compensation, and obtains the first time-frequency resource that has completed phase compensation, and a third time-frequency resource corresponding to the second channel that has completed phase compensation.

Here, the first time-frequency resource corresponds to the first channel, and the data of the first channel is data that needs phase compensation. The third time-frequency resource corresponds to the second channel, and the data of the second channel is data that does not need phase compensation.

In the process, the BBU performs the resource de-mapping on the frequency domain data to obtain the first time-frequency resource that has completed phase compensation in the RRU Hub and the third time-frequency resource corresponding to the second channel that has completed phase compensation.

At S230, the baseband processing unit performs reverse phase compensation based on the third time-frequency resource to obtain the second time-frequency resource.

Here, because the third time-frequency resource corresponds to the second channel, the data of the second channel is data that does not need phase compensation. Therefore, the BBU may perform the reverse phase compensation on the third time-frequency resource to obtain the second time-frequency resource. Because the second time-frequency resource is a resource that has completed the reverse phase compensation, it satisfies the protocol requirements (i.e., the protocol provisions).

For example, the PRACH channel on the BBU may use software to implement the corresponding reverse phase compensation, thereby satisfying the protocol requirements that the PRACH does not require phase compensation.

In the embodiments of the present disclosure, the RF remote unit hub performs phase compensation on the frequency domain data to obtain the frequency domain data with completed phase compensation. The baseband processing unit performs the resource de-mapping on the frequency domain data with completed phase compensation to obtain the first time-frequency resource with completed phase compensation and the third time-frequency resource corresponding to the second channel with completed phase compensation. The baseband processing unit performs the reverse phase compensation based on the third time-frequency resource to obtain the second time-frequency resource. As such, the computing power and capacity resources of the RRU HUB can be saved, and the first time-frequency resource and the second time-frequency resource that satisfy the protocol requirements can be obtained respectively.

In some embodiments, the process S230 “the baseband processing unit performs the reverse phase compensation based on the third time-frequency resource to obtain the second time-frequency resource” may be implemented by the following processes.

At S231, the baseband processing unit constructs second resource block information of the second channel based on the third time-frequency resource.

Here, the resource block (RB) is a unit of bandwidth occupied by a service resource in communication.

In some embodiments, the third time-frequency resource may correspond to time-frequency domain information mapped by PRACH. In the process, the BBU may construct resource block information of PRACH based on the time-frequency domain information mapped by PRACH.

At S232, the baseband processing unit performs the reverse phase compensation on the second resource block information to obtain the second time-frequency resource.

In the process, the BBU may perform the reverse phase compensation on the second resource block information (implemented by software), such that except for the third time-frequency resource, the remaining first time-frequency resources are all phase compensated for uplink.

For example, the BBU may perform the reverse phase compensation on the resource block information constructed by PRACH, such that except for PRACH, the other uplink channels (PUSCH, PUCCH, SRS) are all phase compensated for uplink.

In the embodiments of the present disclosure, the baseband processing unit constructs the second resource block information of the second channel based on the third time-frequency resource. The baseband processing unit performs the reverse phase compensation on the second resource block information to obtain the second time-frequency resource. As such, the reverse phase compensation of the third time-frequency resource can be achieved to obtain the second time-frequency resource that satisfies the protocol requirements.

In some embodiments, as shown in FIG. 3, the process S120 “the baseband processing unit performs the resource de-mapping on the frequency domain data to obtain the first time-frequency resource with phase compensation and the second time-frequency resource without phase compensation” may be implemented by the following processes.

At S310, the baseband processing unit performs the resource de-mapping on the frequency domain data to extract a fourth time-frequency resource corresponding to the first channel and a fifth time-frequency resource corresponding to the second channel.

Here, because the fourth time-frequency resource corresponding to the first channel needs to be phase compensated, and the fifth time-frequency resource corresponding to the second channel does not need to be phase compensated.

In the process, the BBU may first perform resource de-mapping on the time-frequency resources obtained from the RRU HUB to extract the fourth time-frequency resource corresponding to the first channel and the fifth time-frequency resource corresponding to the second channel.

At S320, the baseband processing unit performs the phase compensation on the fourth time-frequency resource to obtain the first time-frequency resource.

Here, the fourth time-frequency resource needs to be phase compensated.

In the process, the BBU only performs the phase compensation on the fourth time-frequency resource to obtain the first time-frequency resource. For example, the phase compensation may be performed by extracting three channels, PUSCH, PUCCH, and SRS after the BBU performs the resource de-mapping, and then implementing phase compensation of the three channels, PUSCH, PUCCH, and SRS in software mode. While the PRACH channel extracted separately after the BBU performs the resource de-mapping does not need phase compensation, thereby satisfying the protocol requirements.

At S330, the baseband processing unit constructs the second time-frequency resource of the second channel based on the fifth time-frequency resource.

In the process, because the fifth time-frequency resource corresponds to the second channel, the second time-frequency resource of the second channel may be constructed based on the fifth time-frequency resource.

In the embodiments of the present disclosure, the baseband processing unit performs the resource de-mapping on the frequency domain data to extract the fourth time-frequency resource corresponding to the first channel and the fifth time-frequency resource corresponding to the second channel. The baseband processing unit performs the phase compensation on the fourth time-frequency resource to obtain the first time-frequency resource. Then, the baseband processing unit constructs the second time-frequency resource of the second channel based on the fifth time-frequency resource. As such, by de-mapping resources at the BBU and performing the phase compensation according to the protocol requirements, the computing power and capacity of the RRU HUB may be more effectively released, and the time-frequency resources that satisfy the protocol requirements may be obtained.

In some embodiments, the process S120 “the RF remote unit hub converts the time domain data received from the RF remote unit into the frequency domain data” may be implemented by the following processes.

At S121, the RF remote unit hub removes symbol prefix of the time domain data to obtain the time domain data with the symbol prefix removed.

In the process, the RRU HUB removes cyclic prefix (CP) of the received time domain data. CP refers to a symbol prefix, which is repeated at the end of the orthogonal frequency division multiplexing (OFDM) technology in the wireless system, and the receiving end is often configured to discard the cyclic prefix samples.

At 122, the RF remote unit hub performs a fast Fourier transform on the time domain data with the symbol prefix removed to obtain the frequency domain data.

Here, FFT is a method for Fourier transform analysis of time domain and frequency domain transformation.

In the process, the RRU HUB may use the fast Fourier transform (FFT) to convert the time domain data after symbol prefix removal into frequency domain data.

For example, the RRU Hub may perform low-level physical layer (Low PHY) processing including CP removal and FFT in a unified format. The Low PHY processing may be implemented using FPGA. In the embodiments of the present disclosure, the RF remote unit hub removes the symbol prefix of the time domain data to obtain the time domain data after the symbol prefix removal. Then, the RF remote unit hub performs the fast Fourier transform on the time domain data after the symbol prefix removal to obtain the frequency domain data. As such, the conversion of the time domain data into the frequency domain data may be implemented in the RRU HUB.

In some embodiments, a universal public radio interface is set on the RF remote unit hub such that the RF remote unit hub is connected to the RF remote unit through the universal public radio interface. An enhanced universal public radio interface is configured on the baseband processing unit such that the baseband processing unit is connected to the RF remote unit hub through the enhanced universal public radio interface.

Here, the interfaces connecting RRU, RRU Hub and BBU are common public radio interface (CPRI) and enhanced common public radio interface (eCPRI). CPRI is based on circuit switching (TDM), while eCPRI is based on packet switching. As such, CPRI naturally carries the synchronization information, while eCPRI needs to be synchronized through the clock synchronization (i.e., PTP) and synchronous Ethernet (i.e., SyncE) technology.

CPRI RRU does not involve Low PHY calculations and has a relatively low cost. Thus, CPRI may be selected as the interface between RRU and RRU Hub. The RRU Hub needs to implement some Low PHY functions. Because the frequency domain data is transmitted between RRU Hub and BBU, eCPRI based on Ethernet switching technology is selected. As such, ordinary network cards of the BBU may implement eCPRI, thereby reducing the cost of the entire base station.

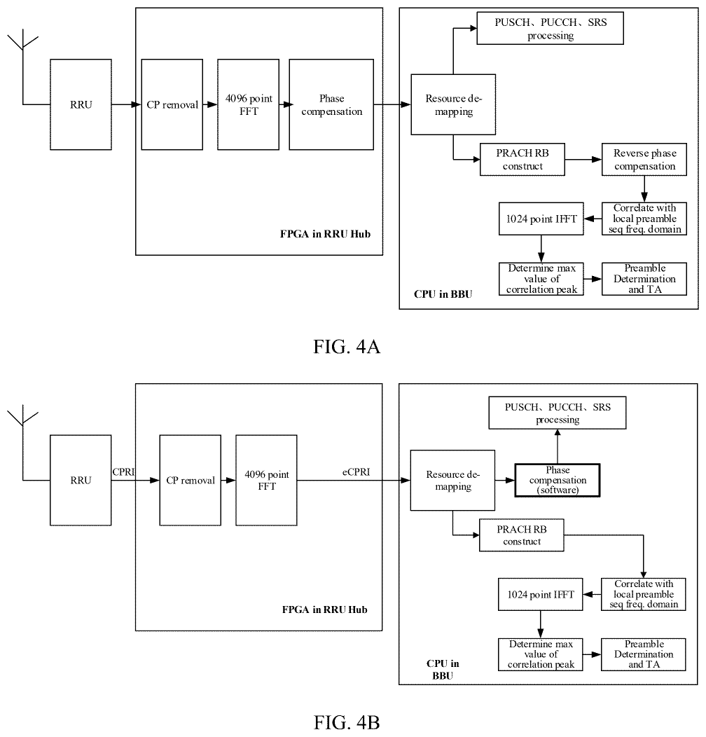

The present disclosure also provides another phase compensation method. FIG. 4A is a flowchart of another phase compensation method according to some embodiments of the present disclosure. As shown in FIG. 4A, the method includes the following processes.

At S401, the RRU Hub removes the CP from the CPRI time domain data received from the RRU to obtain the time domain data with the CP removed. In some embodiments, multiple RRUs and RRU Hubs may be connected using the CPRI, and the RRU Hubs may be connected to the BBU using the eCPRI interface. As such, the present disclosure can be compatible with more models of the RRUs.

In some embodiments, the multiple RRUs and RRU Hubs may be connected using the eCPRI, and the RRU Hubs may be connected to the BBU using the eCPRI interface. As such, part of the calculation of the RRU Hub may be transferred to the RRU for completion, thereby simplifying the function of the RRU Hub.

At S402, the RRU Hub performs the FFT conversion on the time domain data after the CP removal to obtain the frequency domain data.

At S403, the RRU Hub performs the phase compensation on the frequency domain data to obtain the frequency domain data after the phase compensation.

In some embodiments, the processes S402 and S403 are executed, and the CPRI interface, the FFT/IFFT, the CP removal, and the phase compensation functions are implemented on the RRU Hub without distinguishing channels. The BBU then performs the resource de-mapping to distinguish channels and performs different processing corresponding to different channels.

In the process, it can be determined whether the phase compensation is to be implemented using the FPGA of the RRU Hub according to the capacity of the FPGA on the RRU Hub. If the FPGA capacity on the RRU Hub is sufficiently large, the flowchart shown in FIG. 4A is executed, and the phase compensation may be implemented using the FPGA of the RRU Hub. If the FPGA capacity on the RRU Hub is sufficiently small, the flowchart shown in FIG. 4B is executed, and the phase compensation may be implemented using the BBU.

At S404, the BBU performs the resource de-mapping based on the received frequency domain data with the phase compensation sent by the RRU Hub and the time-frequency domain information mapped by PRACH, and obtains two types of data. A first type of data includes PUSH, PUCCH and SRS data, and a second type of data includes PRACH data.

At S405, the PUSH, PUCCH and SRS data are processed.

At S406, RB information of PRACH is constructed.

At S407, the reverse phase compensation is performed on the RB information of PRACH.

After the resource de-mapping, the reverse phase compensation is performed on the constructed RB information of PRACH. As such, the reverse phase compensation can be performed on the RB information of PRACH separately to satisfy the protocol requirements.

At S408, the PRACH data with the reverse phase compensation completed is processed.

In the process, processing the PRACH data that has completed the reverse phase compensation includes: correlating the PRACH data that has completed the reverse phase compensation with local preamble sequence frequency domain, performing 1024-point IFFT to obtain the time domain data, determining a maximum value of a correlation peak based on the time domain data, and determining timing advance (TA) using the preamble based on the determined result of the maximum value of the correlation peak.

In the embodiments of the present disclosure, a 4096-point FFT (uplink) or IFFT (downlink) with a bandwidth of 100 M is implemented on the RRU Hub, without distinguishing channels. The resource mapping of each channel is uniformly implemented on the BBU, and the PRACH, PUSCH, PUCCH and SRS channels are uniformly processed on the BBU. The phase compensation module is implemented on the RRU Hub using FPGA logic, such that the PRACH channel on the corresponding BBU may have the corresponding reverse phase compensation implementation in software. Thus, the protocol requirements that the PRACH does not require phase compensation are satisfied.

The present disclosure provides another phase compensation method. FIG. 4B is a flowchart of another phase compensation method according to some embodiments of the present disclosure. As shown in FIG. 4B, the method includes the following processes.

At S411, the RRU Hub removes the CP from the CPRI time domain data received from the RRU to obtain the time domain data with the CP removed.

At S412, the RRU Hub performs the FFT conversion on the time domain data with the CP removed to obtain the frequency domain data.

At S413, the BBU performs the resource de-mapping on the frequency domain data received from the RRU Hub to obtain two types of data. A first type of data includes PUSH, PUCCH and SRS data, and a second type of data includes PRACH data.

At S414, the phase compensation is performed on the PUSH, PUCCH and SRS data to obtain the PUSH, PUCCH and SRS data with the phase compensation.

The phase compensation is performed on the PUSH, PUCCH and SRS data after the resource de-mapping, such that the phase compensation can be performed on the PUSCH, PUCCH and SRS channels separately.

At S415, the PUSH, PUCCH and SRS data with the phase compensation are processed.

At S416, the RB information of PRACH is constructed.

At S417, the RB information of PRACH is processed.

In the process, constructing the RB information of PRACH includes: correlating the constructed RB information of PRACH with the frequency domain of the local preamble sequence, performing 1024-point IFFT to obtain the time domain data, determining a maximum value of a correlation peak based on the time domain data, and determining the timing advance (TA) using the preamble based on the determined result of the maximum value of the correlation peak.

In the embodiments of the present disclosure, the 4096-point FFT (uplink) or IFFT (downlink) with a bandwidth of 100 M is implemented on the RRU Hub, without distinguishing channels. The resource mapping of each channel is uniformly implemented in the BBU, and the PRACH, PUSCH, PUCCH and SRS channels are uniformly processed in the BBU. The phase compensation may be implemented separately in the BBU after the resource mapping, and the three channels of PUSCH, PUCCH and SRS are extracted separately and implemented in software, and the PRACH channel does not need phase compensation, thereby satisfying the protocol requirements.

Based on the foregoing embodiments, the present disclosure also provides a phase compensation apparatus. The phase compensation apparatus includes the RF remote unit hub and the baseband processing unit. The RF remote unit hub and the baseband processing unit respectively include functional modules, which may be implemented by a processor in an electronic device, or may also be implemented by a specific logic circuit. In the process, the processor may be a central processing unit (CPU), a microprocessor (MPU), a digital signal processor (DSP), or a field programmable gate array (FPGA), etc.

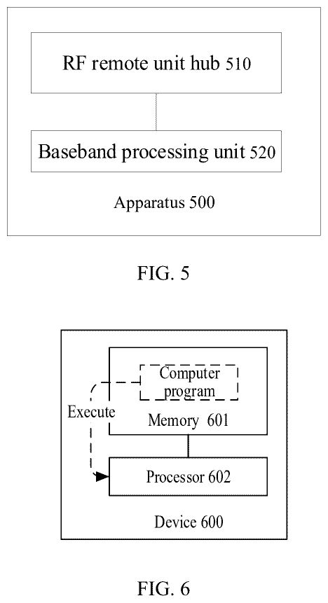

FIG. 5 is a schematic structural diagram of a phase compensation apparatus according to some embodiments of the present disclosure. As shown in FIG. 5, the apparatus 500 includes: an RF remote unit hub 510 configured to convert time domain data received from an RF remote unit into frequency domain data, a baseband processing unit 520 configured to perform resource de-mapping on the frequency domain data to obtain first time-frequency resource that has completed phase compensation and second time-frequency resource that has not completed the phase compensation. The first time-frequency resource corresponds to a first channel, and the second time-frequency resource corresponds to a second channel.

In some embodiments, the RF remote unit hub 510 is further configured to perform the phase compensation on the frequency domain data to obtain the frequency domain data that has completed the phase compensation. The baseband processing unit 520 includes a resource de-mapping module and a reverse phase compensation module. The resource de-mapping module is configured to perform the resource de-mapping on the frequency domain data that has completed the phase compensation to obtain the first time-frequency resource that has completed phase compensation and a third time-frequency resource corresponding to the second channel that has completed phase compensation. The reverse phase compensation module is configured to perform the reverse phase compensation based on the third time-frequency resource to obtain the second time-frequency resource.

In some embodiments, the baseband processing unit 520 further includes a resource construction module for constructing second resource block information of the second channel based on the third time-frequency resource. The reverse phase compensation module is further configured to perform the reverse phase compensation on the second resource block information to obtain the second time-frequency resource.

In some embodiments, the resource de-mapping module is configured to perform the resource de-mapping on the frequency domain data to extract a fourth time-frequency resource corresponding to the first channel and a fifth time-frequency resource corresponding to the second channel. The baseband processing unit 520 includes a phase compensation module for performing the phase compensation on the fourth time-frequency resource to obtain the first time-frequency resource. The resource construction module is configured to construct the second time-frequency resource of the second channel based on the fifth time-frequency resource.

In some embodiments, the radio frequency remote unit hub 510 includes a symbol prefix removal module and a fast Fourier transform module. The symbol prefix removal module is configured to remove the symbol prefix of the time domain data to obtain the time domain data after the symbol prefix removal is completed. The fast Fourier transform module is configured to perform the fast Fourier transform on the time domain data after the symbol prefix removal is completed to obtain the frequency domain data.

In some embodiments, the first channel includes at least one of the following: a physical uplink shared channel, a physical uplink control channel, or a channel sounding reference signal. The second channel is a physical random access channel.

In some embodiments, a universal public wireless interface is configured on the RF remote unit hub such that the RF remote unit hub is connected to the RF remote unit through the universal public wireless interface. An enhanced universal public radio interface is configured on the baseband processing unit such that the baseband processing unit is connected to the RF remote unit hub through the enhanced universal public radio interface.

The description of the above apparatus embodiment is similar to the description of the method embodiments, and has similar beneficial effects as the method embodiments. For technical details not disclosed in the apparatus embodiments of the present disclosure, reference can be made to the description of the method embodiments of the present disclosure for understanding.

It should be noted that in the embodiments of the present disclosure, if the above method is implemented in the form of a software function module and sold or used as an independent product, it may also be stored in a computer-readable storage medium. Based on this understanding, the technical solution of the embodiments of the present disclosure may be essentially or partly reflected in the form of a software product that contributes to the relevant technology. The computer software product is stored in a storage medium, including a plurality of instructions to enable an electronic device (which may be a mobile phone, a tablet computer, a laptop computer, a desktop computer, etc.) to execute all or part of the methods described in each embodiment of the present disclosure. The storage medium may include: a U disk, a mobile hard disk, a read-only memory (ROM), a disk or an optical disk, etc., which stores program codes. As such, the embodiments of the present disclosure are not limited to any specific combination of hardware and software.

Correspondingly, the present disclosure also provides a computer-readable storage medium on which a computer program is stored, and when the computer program is executed by a processor, the processes/steps in the phase compensation method provided in the embodiments of the present disclosure are implemented.

Correspondingly, the present disclosure also provides two electronic devices (including a RF remote unit hub and a baseband processing unit). FIG. 6 is a schematic diagram of a hardware architecture of an electronic device according to some embodiments of the present disclosure. As shown in FIG. 6, the device 600 includes a memory 601 and a processor 602. The memory 601 stores a computer program that can be run on the processor 602. The processor 602 implements the processes/steps in the phase compensation method provided in the embodiments of the present disclosure when executing the computer program.

The memory 601 is configured to store instructions and applications executable by the processor 602, and may also cache data to be processed or processed by the processor 602 and each module in the electronic device 600 (for example, image data, audio data, voice communication data, and video communication data). The memory 601 may be implemented by a flash memory (FLASH) or a random access memory (RAM).

It should be pointed out here that the description of the computer-readable storage medium and device embodiments is similar to the description of the method embodiments, and has similar beneficial effects as the method embodiments. For technical details not disclosed in the computer-readable storage medium and device embodiments of the present disclosure, reference can be made to the description of the method embodiments of the present disclosure for understanding.

It should be understood that the “one embodiment” or “some embodiments” mentioned throughout the specification means that the specific features, structures or characteristics related to the embodiment or embodiments are included in at least one embodiment of the present disclosure. Therefore, “in one embodiment” or “in some embodiments” appearing throughout the specification does not necessarily refer to the same embodiment or embodiments. In addition, these specific features, structures or characteristics may be combined in one or more embodiments in any suitable manner. It should be understood that in various embodiments of the present disclosure, the size of the serial number of each step/process mentioned above does not mean the order of execution. The execution order of each step/process should be determined by its function and internal logic, and should not constitute any limitation on the implementation process of the embodiments of the present disclosure. The serial number of the embodiments of the present disclosure is merely for the description and does not represent the advantages and disadvantages of the embodiments.

It should be noted that in this specification, the term “include”, “comprise” or any other variant thereof is intended to cover non-exclusive inclusion, such that a process, method, article or device including a series of elements includes not only those elements, but also other elements not explicitly listed, or also includes elements inherent to such a process, method, article or device. In the absence of further restrictions, an element defined by the sentence “including a . . . ” does not exclude the existence of other identical elements in the process, method, article or device including the element.

In the embodiments provided in the present disclosure, it should be understood that the disclosed devices and methods may be implemented in other ways. The device embodiments described above are only schematic. For example, the division of the units/modules is only a logical function division. There may be other division methods in actual implementation, such as, multiple units or components can be combined, or can be integrated into another system, or some features can be ignored or not executed. In addition, the coupling, direct coupling, or communication connection between the components shown or discussed can be through some interfaces, and the indirect coupling or communication connection of the device or unit can be electrical, mechanical or other forms.

The units described above as separate components may or may not be physically separated, and the components shown as units may or may not be physical units. They may be located in one place or distributed on multiple network units. Some or all of the units may be selected according to actual needs to achieve the purpose of the scheme of the embodiments.

In addition, all functional units in the embodiments of the present disclosure may be integrated into one processing unit, or each unit may be separately used as a unit, or two or more units may be integrated into one unit. The integrated unit may be implemented in the form of hardware or in the form of hardware plus software functional units.

A person skilled in the art can understand that all or part of the steps/processes of implementing the method embodiments may be completed by hardware related to program instructions, and the program instructions may be stored in a computer-readable storage medium. When the program is executed, the steps/processes of the method embodiments are executed. The storage medium may include a mobile storage device, a read-only memory (ROM), a disk or an optical disk, and other media that can store program instructions.

Alternatively, if the integrated unit of the present disclosure is implemented in the form of a software functional module and sold or used as an independent product, it may also be stored in a computer-readable storage medium. Based on this understanding, the technical solution of the present disclosure, or the part that contributes to the relevant technology, may be embodied in the form of a software product. The computer software product is stored in a storage medium, including a plurality of instructions to enable a computer device (which can be a personal computer, server, or network device, etc.) to execute all or part of the methods described in each embodiment of the present disclosure. The storage medium includes various media that can store program instructions, such as mobile storage devices, ROMs, magnetic disks or optical disks.

The methods disclosed in the method embodiments provided by the present disclosure may be arbitrarily combined to obtain new method embodiments without conflict.

The features disclosed in the product embodiments provided by the present disclosure may be arbitrarily combined to obtain new product embodiments without conflict.

The features disclosed in the method or apparatus embodiments provided by the present disclosure may be arbitrarily combined to obtain new method embodiments or apparatus embodiments without conflict.

The above is merely an implementation method of the present disclosure, but the protection scope of the present disclosure is not limited thereto. An ordinary person skilled in the art can easily think of modifications or replacements within the technical scope disclosed in the present disclosure, which should be covered within the protection scope of the present disclosure.

What is claimed is:

1. A phase compensation method, comprising:
converting, by a radio frequency (RF) remote unit hub, time domain data received from an RF remote unit into frequency domain data; and
performing, by a baseband processing unit, resource de-mapping on the frequency domain data to obtain a first time-frequency resource with phase compensation completed and a second time-frequency resource without phase compensation;
wherein the first time-frequency resource corresponds to a first channel and the second time-frequency resource corresponds to a second channel.

2. The method according to claim 1, wherein performing, by the baseband processing unit, the resource de-mapping on the frequency domain data to obtain the first time-frequency resource with the phase compensation completed and the second time-frequency resource without the phase compensation comprises:
performing, by the RF remote unit hub, the phase compensation on the frequency domain data to obtain the frequency domain data that has completed the phase compensation;
performing, by the baseband processing unit, the resource de-mapping on the frequency domain data that has completed the phase compensation to obtain the first time-frequency resource that has completed the phase compensation and a third time-frequency resource corresponding to the second channel that has completed the phase compensation; and
performing, by the baseband processing unit, reverse phase compensation based on the third time-frequency resource to obtain the second time-frequency resource.

3. The method according to claim 2, wherein performing, by the baseband processing unit, the reverse phase compensation based on the third time-frequency resource to obtain the second time-frequency resource comprises:
constructing, by the baseband processing unit, second resource block information of the second channel based on the third time-frequency resource; and
performing, by the baseband processing unit, the reverse phase compensation on the second resource block information to obtain the second time-frequency resource.

4. The method according to claim 1, wherein performing, by the baseband processing unit, the resource de-mapping on the frequency domain data to obtain the first time-frequency resource with the phase compensation and the second time-frequency resource without the phase compensation comprises:
performing, by the baseband processing unit, the resource de-mapping on the frequency domain data to extract a fourth time-frequency resource corresponding to the first channel and a fifth time-frequency resource corresponding to the second channel;
performing, by the baseband processing unit, the phase compensation on the fourth time-frequency resource to obtain the first time-frequency resource; and
constructing, by the baseband processing unit, the second time-frequency resource of the second channel based on the fifth time-frequency resource.

5. The method according to claim 1, wherein converting, by the RF remote unit hub, the time domain data received from the RF remote unit into the frequency domain data comprises:
removing, by the RF remote unit hub, a symbol prefix of the time domain data to obtain the time domain data after the symbol prefix is removed; and
performing, by the RF remote unit hub, a fast Fourier transform on the time domain data after the symbol prefix is removed to obtain the frequency domain data.

6. The method according to claim 1, wherein:
the first channel includes at least one of a physical uplink shared channel, a physical uplink control channel, or a channel sounding reference signal; and
the second channel includes a physical random access channel.

7. The method according to claim 1, wherein:
a universal public radio interface is configured on the RF remote unit hub, such that the RF remote unit hub is connected to the RF remote unit through the universal public radio interface; and
an enhanced universal public radio interface is configured on the baseband processing unit, such that the baseband processing unit is connected to the RF remote unit hub through the enhanced universal public radio interface.

8. A phase compensation apparatus, comprising:
a radio frequency (RF) remote unit hub configured to convert time domain data received from an RF remote unit into frequency domain data; and
a baseband processing unit configured to perform resource de-mapping on the frequency domain data to obtain a first time-frequency resource that has completed phase compensation and a second time-frequency resource without the phase compensation;
wherein the first time-frequency resource corresponds to a first channel and the second time-frequency resource corresponds to a second channel.

9. The apparatus according to claim 8, wherein when performing the resource de-mapping on the frequency domain data to obtain the first time-frequency resource with the phase compensation completed and the second time-frequency resource without the phase compensation:
the RF remote unit hub performs the phase compensation on the frequency domain data to obtain the frequency domain data that has completed the phase compensation;
the baseband processing unit performs the resource de-mapping on the frequency domain data that has completed the phase compensation to obtain the first time-frequency resource that has completed the phase compensation and a third time-frequency resource corresponding to the second channel that has completed the phase compensation; and
the baseband processing unit performs reverse phase compensation based on the third time-frequency resource to obtain the second time-frequency resource.

10. The apparatus according to claim 9, wherein when performing the reverse phase compensation based on the third time-frequency resource to obtain the second time-frequency resource:
the baseband processing unit constructs second resource block information of the second channel based on the third time-frequency resource; and
the baseband processing unit performs the reverse phase compensation on the second resource block information to obtain the second time-frequency resource.

11. The apparatus according to claim 8, wherein when performing the resource de-mapping on the frequency domain data to obtain the first time-frequency resource with the phase compensation and the second time-frequency resource without the phase compensation:
by the baseband processing unit performs the resource de-mapping on the frequency domain data to extract a fourth time-frequency resource corresponding to the first channel and a fifth time-frequency resource corresponding to the second channel;
the baseband processing unit performs the phase compensation on the fourth time-frequency resource to obtain the first time-frequency resource; and
the baseband processing unit constructs the second time-frequency resource of the second channel based on the fifth time-frequency resource.

12. The apparatus according to claim 8, wherein when converting the time domain data received from the RF remote unit into the frequency domain data comprises:
the RF remote unit hub removes a symbol prefix of the time domain data to obtain the time domain data after the symbol prefix is removed; and
the RF remote unit hub performs a fast Fourier transform on the time domain data after the symbol prefix is removed to obtain the frequency domain data.

13. The apparatus according to claim 8, wherein:
the first channel includes at least one of a physical uplink shared channel, a physical uplink control channel, or a channel sounding reference signal; and
the second channel includes a physical random access channel.

14. The method according to claim 8, wherein:
a universal public radio interface is configured on the RF remote unit hub, such that the RF remote unit hub is connected to the RF remote unit through the universal public radio interface; and
an enhanced universal public radio interface is configured on the baseband processing unit, such that the baseband processing unit is connected to the RF remote unit hub through the enhanced universal public radio interface.

15. A computer-readable storage medium storing a computer program, wherein when being executed by a processor, the computer program causes the processor to:
convert, by a radio frequency (RF) remote unit hub, time domain data received from an RF remote unit into frequency domain data; and
perform, by a baseband processing unit, resource de-mapping on the frequency domain data to obtain a first time-frequency resource with phase compensation completed and a second time-frequency resource without phase compensation;
wherein the first time-frequency resource corresponds to a first channel and the second time-frequency resource corresponds to a second channel.

16. The computer-readable storage medium according to claim 15, wherein when performing the resource de-mapping on the frequency domain data to obtain the first time-frequency resource with the phase compensation completed and the second time-frequency resource without the phase compensation, the processor is further configured to:
perform, by the RF remote unit hub, the phase compensation on the frequency domain data to obtain the frequency domain data that has completed the phase compensation;
perform, by the baseband processing unit, the resource de-mapping on the frequency domain data that has completed the phase compensation to obtain the first time-frequency resource that has completed the phase compensation and a third time-frequency resource corresponding to the second channel that has completed the phase compensation; and
perform, by the baseband processing unit, reverse phase compensation based on the third time-frequency resource to obtain the second time-frequency resource.

17. The computer-readable storage medium according to claim 16, wherein when performing the reverse phase compensation based on the third time-frequency resource to obtain the second time-frequency resource, the processor is further configured to:
construct, by the baseband processing unit, second resource block information of the second channel based on the third time-frequency resource; and
perform, by the baseband processing unit, the reverse phase compensation on the second resource block information to obtain the second time-frequency resource.

18. The computer-readable storage medium according to claim 15, wherein when performing the resource de-mapping on the frequency domain data to obtain the first time-frequency resource with the phase compensation and the second time-frequency resource without the phase compensation, the processor is further configured to:
perform, by the baseband processing unit, the resource de-mapping on the frequency domain data to extract a fourth time-frequency resource corresponding to the first channel and a fifth time-frequency resource corresponding to the second channel;
perform, by the baseband processing unit, the phase compensation on the fourth time-frequency resource to obtain the first time-frequency resource; and
construct, by the baseband processing unit, the second time-frequency resource of the second channel based on the fifth time-frequency resource.

19. The computer-readable storage medium according to claim 15, wherein when converting the time domain data received from the RF remote unit into the frequency domain data, the processor is further configured to:
remove, by the RF remote unit hub, a symbol prefix of the time domain data to obtain the time domain data after the symbol prefix is removed; and
perform, by the RF remote unit hub, a fast Fourier transform on the time domain data after the symbol prefix is removed to obtain the frequency domain data.

20. The computer-readable storage medium according to claim 15, wherein:
the first channel includes at least one of a physical uplink shared channel, a physical uplink control channel, or a channel sounding reference signal; and
the second channel includes a physical random access channel.
